(19) United States
(12) Patent Application Publication
(10) Pub. No.: US 2023/0409830 A1
(43) Pub. Date: Dec. 21, 2023

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Toshiyuki MITSUI, Kanagawa (JP)

(73) Assignee: FUJIFILM Business Innovation Corp., Tokyo (JP)

(21) Appl. No.: 17/983,404

(22) Filed: Nov. 9, 2022

(30) Foreign Application Priority Data
Jun. 17, 2022 (JP) 2022-098384

(51) Int. Cl. G06F 40/268; G06F 40/166

(52) U.S. Cl. CPC G06F 40/268; G06F 40/166

(57) ABSTRACT

An information processing apparatus includes a processor configured to acquire a summary sentence obtained by summarizing an original text, and perform control such that frequent appearance parts of words included in the summary sentence in the original text are displayed as corresponding parts in the original text corresponding to the summary sentence in a case where the summary sentence is designated.

### CROSS-REFERENCE TO RELATED APPLICATIONS

This application is based on and claims priority under 35 USC 119 from Japanese Patent Application No. 2022-098384 filed Jun. 17, 2022.

### BACKGROUND

### (i) Technical Field

The present disclosure relates to an information processing apparatus, a non-transitory computer readable medium storing an information processing program, and an information processing method.

### (ii) Related Art

For example, JP2000-148758A describes a parallel translation associating method for automatically associating an original text that is a translation source with a translated text after translation. In this parallel translation associating method, the original text and the translated text are input, keywords are extracted from the original text and the translated text, the extracted keywords are converted into an intermediate language by an intermediate language generation dictionary, and the original text and the translated text are associated from a relationship between intermediate language keywords included in the translated text and intermediate language keywords included in the original text.

JP2000-194702A describes a sentence summarization method for summarizing an original text as a short sentence. In this sentence summarization method, the original text is retained for each structure unit constituting the sentence, a summarized sentence for each structure unit is retained in association with the original text, and the retained corresponding original text is output in a case where an instruction about an original text output of the summarized sentence for each displayed structure unit is given.

### SUMMARY

Incidentally, there is a technology for extracting key sentences in the original text from the original text, creating the summary sentences, determining corresponding parts between the summary sentences and the original text, and displaying the corresponding parts of the original text for the summary sentences.

However, with the above technology, unless the summary sentences are created by extracting the key sentences from the original text, the key sentences for the summary sentences cannot be understood, and the corresponding parts of the original text cannot be displayed for the summary sentences.

Aspects of non-limiting embodiments of the present disclosure relate to an information processing apparatus, a non-transitory computer readable medium storing an information processing program, and an information processing method that can display corresponding parts of an original text to summary sentences even though the summary sentences are not created by extracting key sentences from the original text.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to acquire a summary sentence obtained by summarizing an original text, and perform control such that frequent appearance parts of words included in the summary sentence in the original text are displayed as corresponding parts in the original text corresponding to the summary sentence in a case where the summary sentence is designated.

### BRIEF DESCRIPTION OF THE DRAWINGS

Exemplary embodiment(s) of the present invention will be described in detail based on the following figures, wherein:

FIG. 1 is a diagram illustrating an example of a configuration of a summary processing system according to an exemplary embodiment;

FIG. 2 is a block diagram illustrating an example of an electrical configuration of the summary processing apparatus according to the exemplary embodiment;

FIG. 3 is a block diagram illustrating an example of a functional configuration of the summary processing apparatus according to the exemplary embodiment;

FIG. 4 is a diagram illustrating an example of an original text page included in an original text according to the exemplary embodiment;

FIG. 5 is a diagram illustrating an example of a summary according to the exemplary embodiment;

FIG. 6 is a diagram illustrating an example of a relationship between words in a summary sentence and TF-IDFs according to the exemplary embodiment;

FIG. 7 is a diagram illustrating an example of frequent appearance parts of the original text corresponding to the summary sentence according to the exemplary embodiment;

FIG. 8 is a diagram illustrating another example of the relationship between the words in the summary sentence and the TF-IDFs according to the exemplary embodiment;

FIG. 9 is a diagram illustrating another example of the frequent appearance parts of the original text corresponding to the summary sentence according to the exemplary embodiment;

FIG. 10 is a diagram for describing frequent appearance part exclusion processing according to the exemplary embodiment;

FIG. 11 is a front view illustrating an example of a corresponding part display screen in a case where there is one corresponding part corresponding to the summary sentence;

FIG. 12 is a front view illustrating an example of the corresponding part display screen in a case where there are a plurality of corresponding parts corresponding to the summary sentence;

FIG. 13 is a front view illustrating an example of a display order setting screen according to the exemplary embodiment;

FIG. 14 is a front view illustrating an example of a corresponding part display screen in a case where there is one corresponding part corresponding to a word in the summary sentence;

FIG. 15 is a front view illustrating an example of a corresponding part display screen in a case where there is no corresponding part corresponding to the summary sentence; and

FIG. 16 is a flowchart illustrating an example of a flow of processing by a summary processing program according to the exemplary embodiment.

### DETAILED DESCRIPTION

Hereinafter, an exemplary embodiment of the present disclosure will be described in detail with reference to the drawings. Components and processing having the same operations, actions, and functions are given the same reference signs throughout the drawings, and redundant description may be omitted as appropriate. Each drawing is only schematically illustrated to the extent that the technology of the present disclosure can be fully understood. Thus, the technology of the present disclosure is not limited only to the illustrated examples. In the present exemplary embodiment, descriptions of configurations that are not directly related to the technology of the present disclosure and well-known configurations may be omitted.

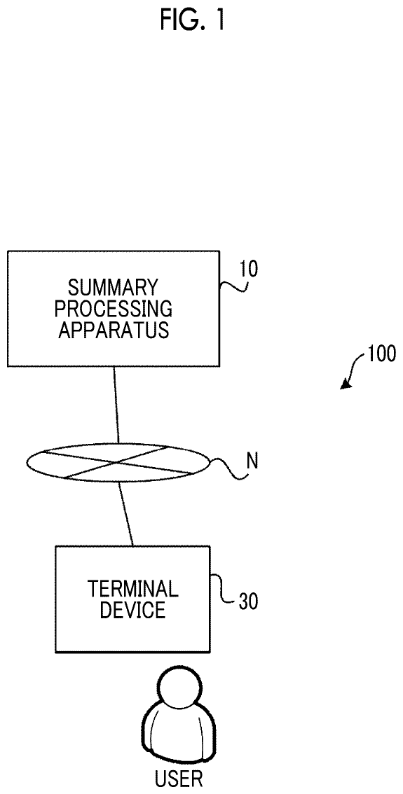

FIG. 1 is a diagram illustrating an example of a configuration of a summary processing system 100 according to the present exemplary embodiment.

As illustrated in FIG. 1, a summary processing system 100 according to the present exemplary embodiment includes a summary processing apparatus 10 and a terminal device 30. Although one terminal device is illustrated in the example of FIG. 1, the number of terminal devices is any number. The summary processing apparatus 10 is an example of an information processing apparatus.

The terminal device 30 is a terminal device used by a user of a summary processing service, and is, for example, an information terminal such as a smartphone, a tablet terminal, or a personal computer (PC). The user accesses the summary processing apparatus 10 via a network N to obtain a summary of an original text from the summary processing apparatus 10 by operating the terminal device 30.

The summary processing apparatus 10 is connected to the terminal device 30 via the network N. Examples of the network N include the Internet, a local area network (LAN), a wide area network (WAN), and the like. The summary processing apparatus 10 is, for example, a server computer disposed on a cloud, accepts an original text input by the user from the terminal device 30, and outputs a summary of the original text to the terminal device 30.

In the example of FIG. 1, although the summary processing apparatus 10 accepts the original text input by the user from the terminal device 30, the present disclosure is not limited thereto. The summary processing apparatus may accept the original text directly input by the user from an operation unit of the summary processing apparatus without using the terminal device 30.

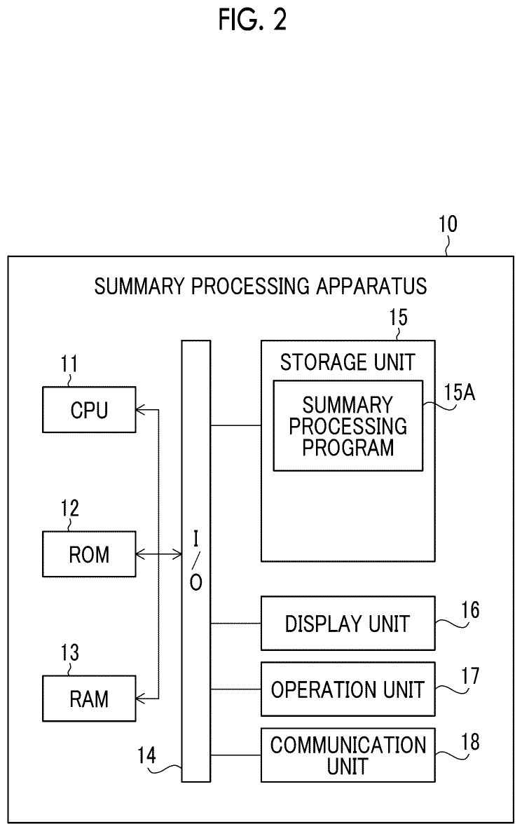

FIG. 2 is a block diagram illustrating an example of an electrical configuration of the summary processing apparatus 10 according to the present exemplary embodiment.

As illustrated in FIG. 2, the summary processing apparatus 10 according to the present exemplary embodiment includes a central processing unit (CPU) 11, a read only memory (ROM) 12, a random access memory (RAM) 13, an input and output interface (I/O) 14, a storage unit 15, a display unit 16, an operation unit 17, and a communication unit 18.

The CPU 11, the ROM 12, the RAM 13, and the I/O 14 are connected via a bus. Functional units including the storage unit 15, the display unit 16, the operation unit 17 and the communication unit 18 are connected to the I/O 14. These functional units can mutually communicate with the CPU 11 via the I/O 14.

The CPU 11, the ROM 12, the RAM 13, and the I/O 14 constitute a controller. The controller may be a sub-controller that controls a part of an operation of the summary processing apparatus 10, or may be a part of a main controller that controls an overall operation of the summary processing apparatus 10. An integrated circuit such as a large scale integration (LSI) or an IC chipset is used for a part or all of blocks of the controller. An individual circuit may be used for each of the blocks, or a circuit in which a part or all of the blocks are integrated may be used. The blocks may be provided integrally, or a part of the blocks may be provided separately. In each of the blocks, a part thereof may be separately provided. A dedicated circuit or a general-purpose processor may be used for integration of the controller, and is not limited to the LSI.

Examples of the storage unit 15 include a hard disk drive (HDD), a solid state drive (SSD), a flash memory, or the like. The storage unit 15 stores a summary processing program 15A for executing summary processing according to the present exemplary embodiment. The summary processing program 15A may be stored in the ROM 12.

For example, the summary processing program 15A may be installed in advance in the summary processing apparatus 10. The summary processing program 15A may be implemented by being stored in a non-volatile storage medium or being distributed via the network N and being installed in the summary processing apparatus 10 as appropriate. Examples of the non-volatile storage medium include a compact disc read only memory (CD-ROM), a magneto-optical disc, a HDD, a digital versatile disc read only memory (DVD-ROM), a flash memory, a memory card, and the like.

Examples of the display unit 16 include a liquid crystal display (LCD), an organic electro luminescence (EL) display, and the like. The display unit 16 may integrally have a touch panel. Devices for operation input such as a keyboard and a mouse are provided in the operation unit 17. The display unit 16 and the operation unit 17 accept various instructions from the user of the summary processing apparatus 10. The display unit 16 displays various kinds of information such as results of processing executed in accordance with the instructions accepted from the user, notifications regarding the processing, and the like.

As an example, the communication unit 18 is connected to the network N such as the Internet, the LAN, or the WAN, and can communicate with the terminal device 30 via the network N.

Incidentally, as described above, in the technology of extracting key sentences in the original text from the original text, creating summary sentences, determining the corresponding parts of the summary sentences and the original text, and displaying the corresponding parts of the original text for the summary sentences, unless the summary sentences are created by extracting the key sentences from the original text, the key sentences for the summary sentences cannot be understood, and the corresponding parts of the original text cannot be displayed for the summary sentences.

In contrast, the summary processing apparatus 10 according to the present exemplary embodiment acquires summary sentences obtained by summarizing the original text, and performs control such that frequent appearance parts of words included in the summary sentences in the original text are displayed as the corresponding parts in the original text corresponding to the summary sentence in a case where the summary sentences are designated.

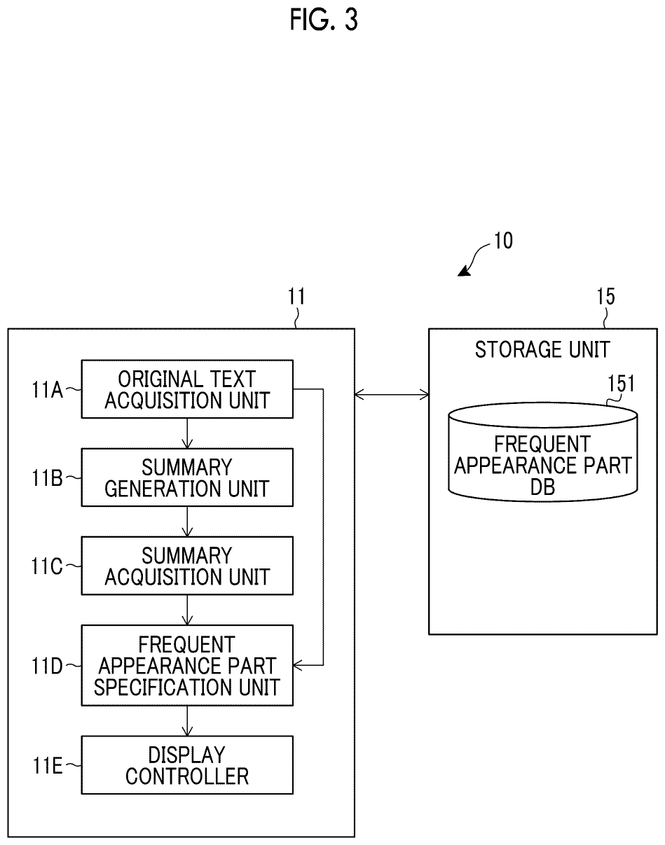

Specifically, the CPU 11 of the summary processing apparatus 10 according to the present exemplary embodiment functions as each unit illustrated in FIG. 3 by writing the summary processing program 15A stored in the storage unit 15 into the RAM 13 and executing the summary processing program. The CPU 11 is an example of a processor.

FIG. 3 is a block diagram illustrating an example of a functional configuration of the summary processing apparatus 10 according to the present exemplary embodiment.

As illustrated in FIG. 3, the CPU 11 of the summary processing apparatus 10 according to the present exemplary embodiment functions as an original text acquisition unit 11A, a summary generation unit 11B, a summary acquisition unit 11C, a frequent appearance part specification unit 11D, and a display controller 11E.

The original text acquisition unit 11A acquires an original text to be summarized. The original text mentioned herein includes, for example, documents, images, moving images, dialogue and conversation histories, web pages, and the like.

The summary generation unit 11B generates summary sentences from the original text acquired by the original text acquisition unit 11A. A summary artificial Intelligence (AI) application (for example, “ELYZA DIGEST (https://www.digest.elyza.ai/)” or the like) using an artificial Intelligence model is used, for example, to generate the summary sentences.

The summary acquisition unit 11C acquires the summary sentences generated by the summary generation unit 11B or summary sentences from an external provider.

The frequent appearance part specification unit 11D receives, as an input, the original text acquired by the original text acquisition unit 11A, receives, as an input, the summary sentences acquired by the summary acquisition unit 11C, and specifies frequent appearance parts of words included in the summary sentences in the original text.

Specifically, for each word included in the summary sentences, the frequent appearance part specification unit 11D calculates an index value represented by an appearance frequency of the word and a degree of rarity of the word in the entire original text for each original text unit obtained by dividing the original text into predetermined units, and specifies the frequent appearance parts by using the calculated index value. The division unit may be, for example, a page unit or a chapter, clause, or paragraph unit. The frequent appearance part may not be a most frequent appearance part, and is, for example, a part where the sum of the index values calculated for each word included in the summary sentences is equal to or greater than a threshold value. For example, Term Frequency-Inverse Document Frequency (TF-IDF) is applied to the index value. In TF-IDF, TF represents the appearance frequency of the word, and IDF represents the degree of rarity of the word in the entire original text.

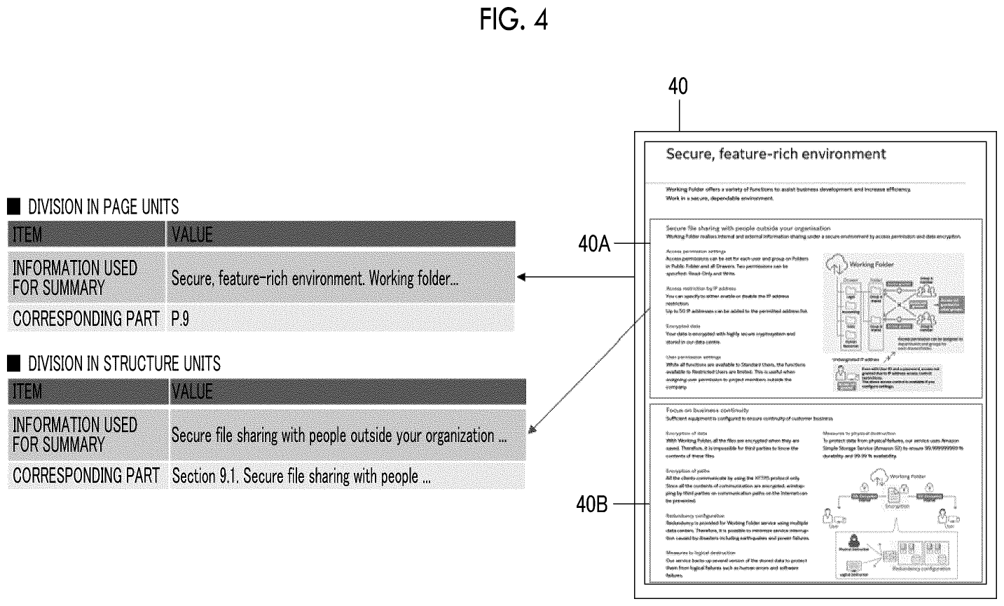

Here, a specific description of frequent appearance part specification processing by the frequent appearance part specification unit 11D will be described with reference to FIGS. 4 to 10.

FIG. 4 is a diagram illustrating an example of an original text page 40 included in the original text according to the present exemplary embodiment. In the example of FIG. 4, the original text page 40 indicates any page (for example, “P. 9”) included in the original text acquired by the original text acquisition unit 11A, and includes original text paragraphs 40A and 40B that are a plurality of paragraphs in the page.

As an example, as illustrated in FIG. 4, the frequent appearance part specification unit 11D divides the acquired original text into page units, and retains, as data after division, information used for a summary for each page unit and a corresponding part in association with each other. In the example of FIG. 4, the original text page 40 represents “P. 9 (page 9)” of the original text, the entire page of “P. 9 (page 9)” is the information used for the summary, and “P. 9 (page 9)” is the corresponding part.

The frequent appearance part specification unit 11D may divide the acquired original text into structural units (for example, paragraph units). For example, in a case where the original text page 40 illustrated in FIG. 4 is divided into paragraph units, information used for a summary for each paragraph unit and a corresponding part are retained as data after division in association with each other. In the example of FIG. 4, the original text paragraph represents a paragraph of “9. 1 Secure file sharing with people outside your organization” on the original text page 40, the entire paragraph of “P. 9 Secure file sharing with people outside your organization” is the information used for the summary, and “P. 9 Secure file sharing with people outside your organization” is the corresponding part.

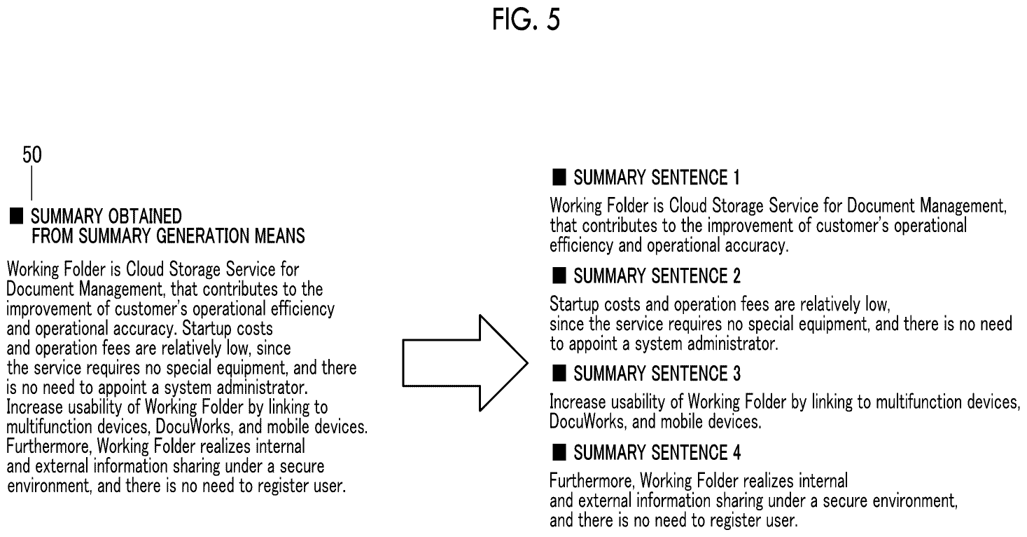

FIG. 5 is a diagram illustrating an example of a summary 50 according to the present exemplary embodiment. In the example of FIG. 5, the summary 50 is a summary sentence obtained by being summarized by the summary generation unit 11B.

For example, as illustrated in FIG. 5, the frequent appearance part specification unit 11D divides the summary into specific units (for example, one sentence). In the example of FIG. 5, the summary 50 is divided into a plurality of summary sentences 1 to 4.

The frequent appearance part specification unit 11D performs morphological analysis on each of the plurality of summary sentences 1 to 4, and obtains a set of words excluding conjunctions and prepositions. TF-IDF is calculated between each word included in the obtained set of words and the information used for the summary illustrated in FIG. 4 described above.

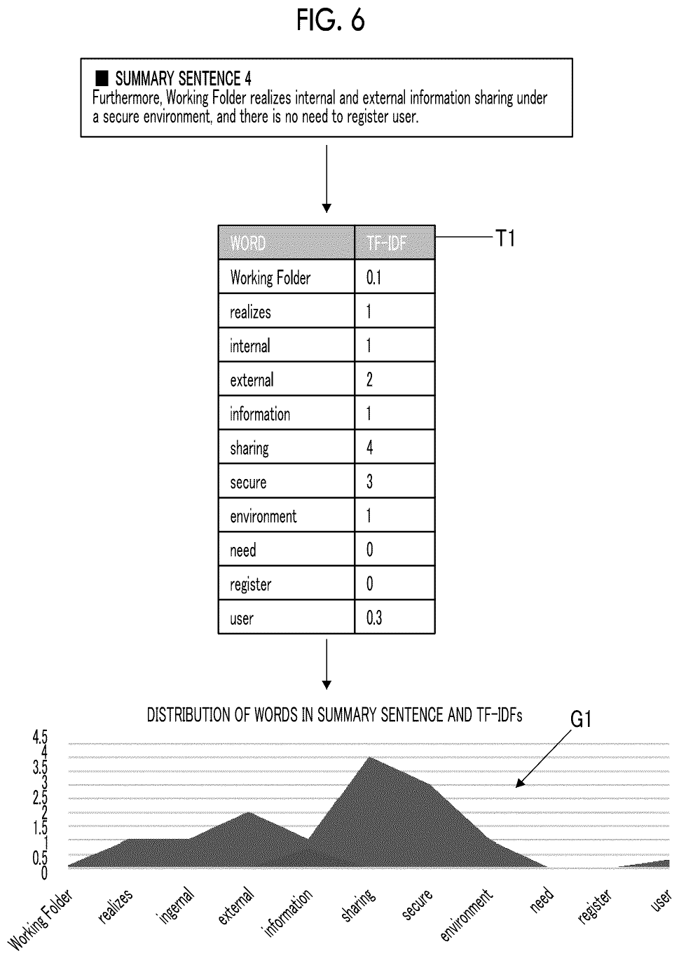

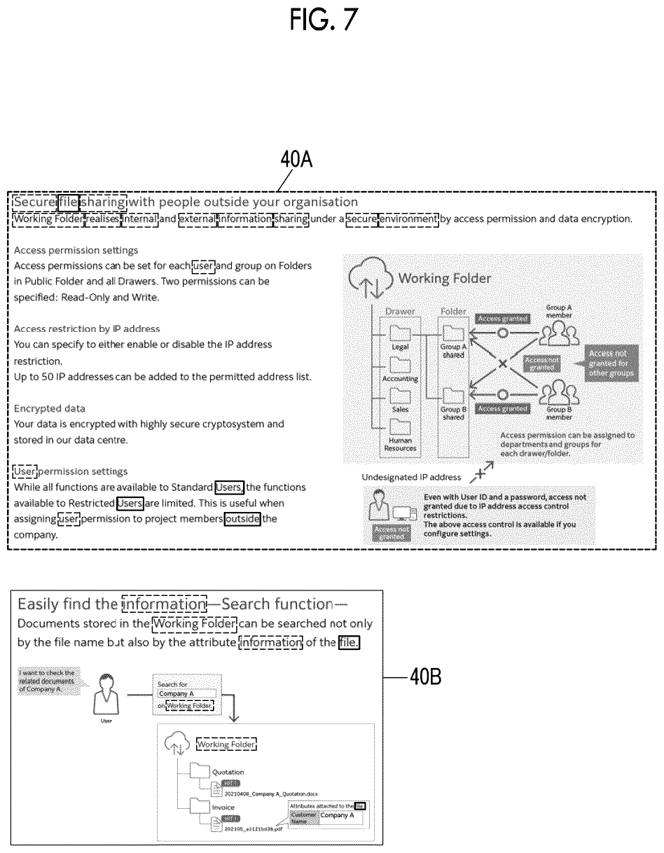

FIG. 6 is a diagram illustrating an example of a relationship between the word in the summary sentence and TF-IDF according to the present exemplary embodiment. FIG. 7 is a diagram illustrating an example of the frequent appearance part of the original text corresponding to the summary sentence according to the present exemplary embodiment. In the examples of FIGS. 6 and 7, a case where there is one frequent appearance part corresponding to the summary sentence will be described.

In table T1 illustrated in FIG. 6, a case where the morphological analysis is performed on the summary sentence 4 illustrated in FIG. 5 described above, the set of words excluding conjunctions and prepositions is obtained, and TF-IDF is calculated for each word included in the obtained set of words is illustrated. Graph G1 illustrated in FIG. 6 illustrates a distribution of the words and the TF-IDFs included in the summary sentence 4. A horizontal axis indicates a word, and a vertical axis indicates TF-IDF. A value of TF-IDF is large for a characteristic word that expresses the gist of the original text (that is, a word that appears only in a corresponding part). Even though a word used in the entire original text appears, the value is small. In the example of FIG. 6, values of “sharing” and “secure” are relatively large, and values of “Working Folder” and “user” are relatively small.

For the “information used for the summary” of the acquired original text, for example, a part where the sum of TF-IDFs calculated for the words included in the summary sentence 4 is equal to or greater than a threshold value is specified as the frequent appearance part. An appropriate value is set by the user for the threshold value used to specify the frequent appearance part. In the case of the summary sentence 4 illustrated in FIG. 6, as illustrated in FIG. 7, the original text paragraph 40A of the original text page 40 is specified as the frequent appearance part.

In the original text paragraph 40A illustrated in FIG. 7, vector conversion is performed for each word, and words with a high degree of similarity (=similar words) are regarded as the same word. In other words, the frequent appearance part specification unit 11D may specify, as the frequent appearance part, a part where a word included in the summary sentence and similar words of the word appear frequently. A method for extracting the similar words is not particularly limited, and various known technologies are used. In this original text paragraph 40A, words surrounded by a dotted line represent the words included in the summary sentence 4. Here, “secure”, “sharing”, “Working Folder”, “realizes”, “internal”, “external”, “information”, “environment”, and “user” correspond to these words. On the other hand, words surrounded by a solid line represent words with high degrees of similarity to the words included in the summary sentence 4. Here, “file”, “Users”, “outside”, and “shared” correspond to these words.

On the other hand, the original text paragraph 40B illustrated in FIG. 7 is not specified as the frequent appearance part of the summary sentence 4 illustrated in FIG. 6. In the original text paragraph 40B, words surrounded by a dotted line represent the words included in the summary sentence 4. Here, “information” and “Working Folder” correspond to these words. In the original text paragraph 40B, “file” corresponds to the word with a high degree of similarity to the word included in the summary sentence 4. In this case, since the sum of TF-IDFs calculated for each word included in the summary sentence 4 is less than the threshold value, this word is not specified as the frequent appearance part.

In the examples of FIGS. 6 and 7 described above, although a case where there is one frequent appearance part corresponding to the summary sentence has been described, a case where there are a plurality of frequent appearance parts corresponding to the summary sentence will be described below.

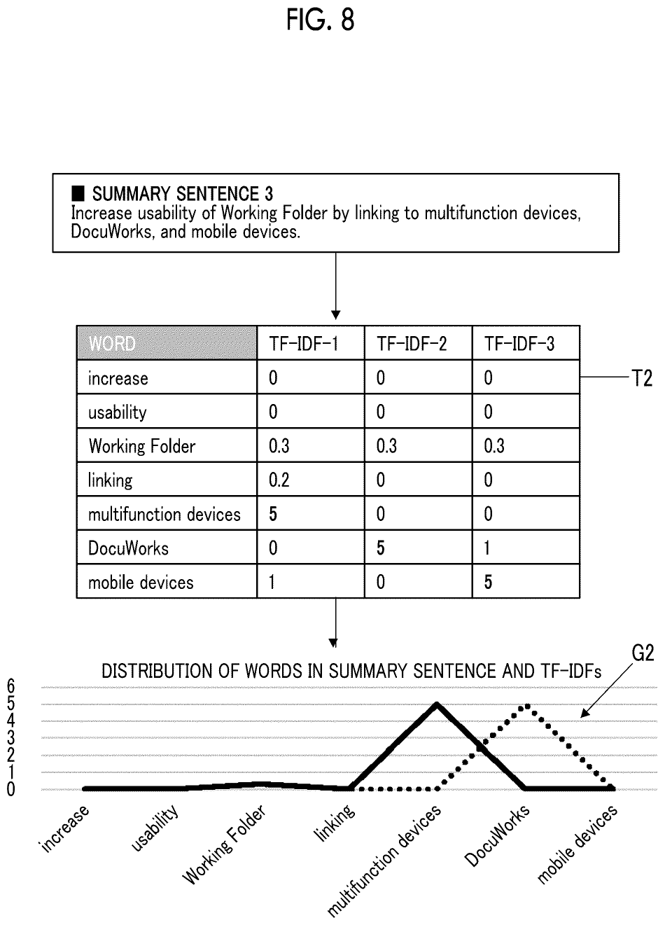

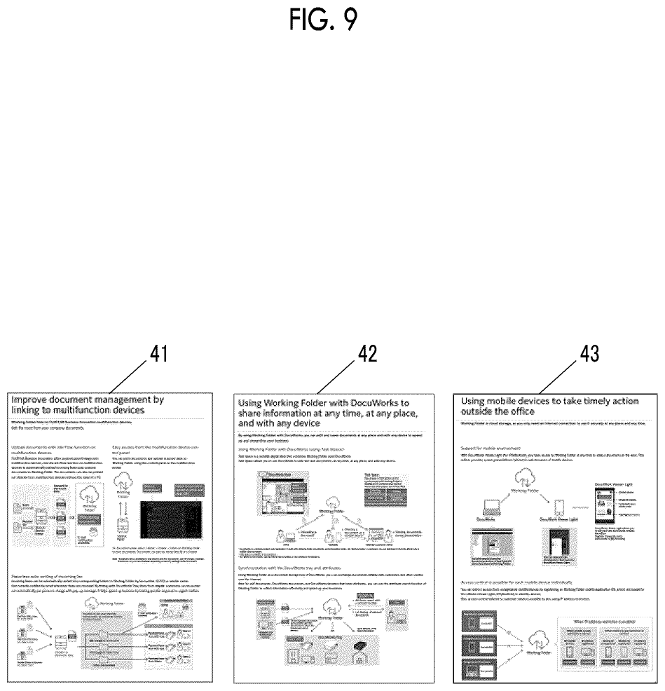

FIG. 8 is a diagram illustrating another example of the relationship between the words in the summary sentence and the TF-IDF according to the present exemplary embodiment. FIG. 9 is a diagram illustrating another example of the frequent appearance parts of the original text corresponding to the summary sentence according to the present exemplary embodiment. In the examples of FIGS. 8 and 9, a case where there are the plurality of frequent appearance parts corresponding to the summary sentence.

In Table T2 illustrated in FIG. 8, the morphological analysis is performed on the summary sentence 3 illustrated in FIG. 5 described above, the set of words excluding conjunctions and prepositions is obtained, and a case where a plurality of TF-IDFs (TF-IDFs 1 to 3) are calculated for each word included in the obtained set of words is illustrated. In the TF-IDF 1, a word of “multifunction devices” has a largest value, in the TF-IDF 2, a word of “DocuWorks (registered trademark)” has a largest value, and in the TF-IDF 3, a word of “mobile devices” has a largest value. Graph G2 illustrated in FIG. 8 illustrates a distribution of the words and the TF-IDFs included in the summary sentence 3. A horizontal axis indicates a word, and a vertical axis indicates TF-IDF. A solid line corresponds to the TF-IDF 1, a dotted line corresponds to the TF-IDF 2, and the TF-IDF3 is omitted.

For the “information used for the summary” of the acquired original text, for example, a part including a word of which a value of the TF-IDF calculated for each word included in the summary sentence 3 is equal to or greater than a threshold value may be specified as the frequent appearance part. In the case of the summary sentence 3 illustrated in FIG. 8, as illustrated in FIG. 9, original text pages 41, 42, and 43 are specified as the plurality of frequent appearance parts. Specifically, the original text which the TF-IDF 1 is calculated, the original text page 42 corresponds to “page 4” of the original text from which the TF-IDF 2 is calculated, and the original text page 43 corresponds to “page 7” of the original text from which the TF-IDF 3 is calculated.

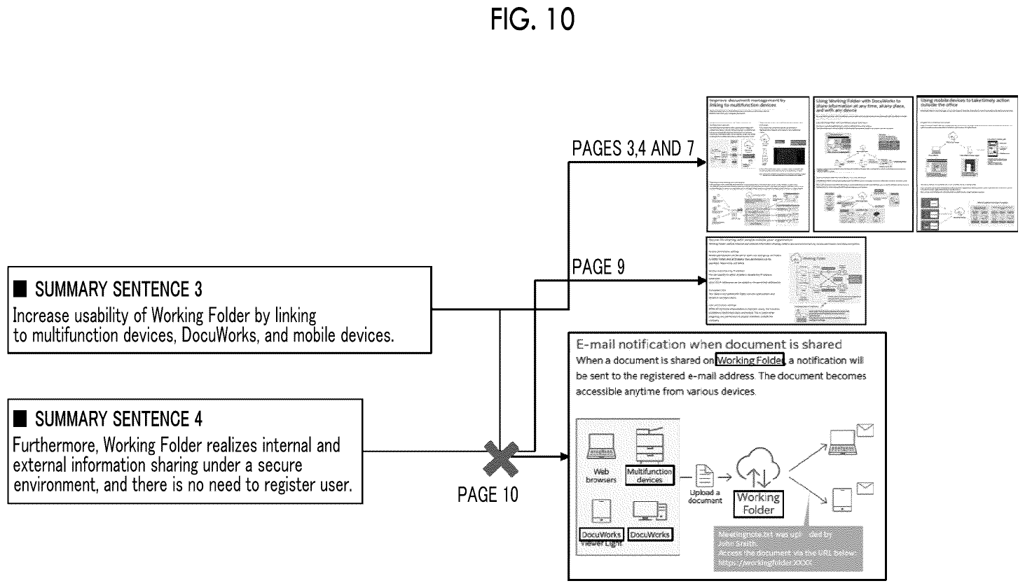

Here, the summary sentence includes a first summary sentence and a second summary sentence before or after the first summary sentence. In a case where the plurality of frequent appearance parts are specified for the first summary sentence, the frequent appearance part specification unit 11D may exclude one or more frequent appearance parts from the plurality of frequent appearance parts by using the contextual relationship with the frequent appearance part in the original text corresponding to the second summary sentence. This frequent appearance part exclusion processing will be described with reference to FIG. 10.

FIG. 10 is a diagram for describing the frequent appearance part exclusion processing according to the present exemplary embodiment.

As illustrated in FIG. 10, for example, for the summary sentence 3 (first summary sentence) in which “page 7” and “page 10” of the original text are specified as the plurality of frequent appearance parts, the frequent appearance part that satisfies the following condition 1 or condition 2 is adopted in consideration of “page 9” of the original text as the frequent appearance part corresponding to the subsequent summary sentence 4 (second summary sentence).
(Condition 1) there is after the frequent appearance part corresponding to the previous summary sentence.
(Condition 2) there is before the frequent appearance part corresponding to the subsequent summary sentence.

In the example of FIG. 10, since the frequent appearance parts “pages 3, 4, and 7” corresponding to the summary sentence 3 is before the frequent appearance part “page 9” corresponding to the subsequent summary sentence 4, the condition 2 is satisfied, and since the frequent appearance part “page 10” corresponding to the summary sentence 3 is after the frequent appearance part “page 9” corresponding to the subsequent summary sentence 4, the condition 2 is not satisfied. Thus, the frequent appearance parts “pages 3, 4, and 7” are adopted, and the frequent appearance part “page 10” is excluded.

Since the summary sentence is usually generated according to an order of pages of the original text, by considering the frequent appearance parts corresponding to the previous and subsequent summary sentences, frequent appearance parts with low relevance to the summary sentence are excluded. Accordingly, it is not necessary for the user to check the frequent appearance parts with low relevance.

The frequent appearance part specification unit 11D may exclude one or more frequent appearance parts from the plurality of frequent appearance parts by using at least one of verbs and adjectives related to the words included in the first summary sentence, in addition to the contextual relationship with the frequent appearance part in the original text corresponding to the second summary sentence.

Specifically, the verbs or adjectives related to the words included in the summary sentence 3 (first summary sentence) are, for example, verbs or adjectives in the vicinity of the word, or verbs or adjectives included in the same clause as the word. In the example of FIG. 10, in a case where the word included in the summary sentence 3 (first summary sentence) is, for example, “multifunction devices”, the same clause as “multifunction devices” includes “linking”. In this case, in a case where “linking” is included in the frequent appearance part “page 7” corresponding to the summary sentence 3 (first summary sentence), the frequent appearance part “page 7” is adopted, and in a case where “linking” is not included, the frequent appearance part “page 7” is excluded.

In addition to considering the frequent appearance parts corresponding to the previous and subsequent summary sentences, the frequent appearance parts having low relevance to the summary sentences are excluded by considering the contents of the summary sentences.

The frequent appearance part specification unit 11D may retain the frequent appearance part in the original text specified as described above in association with the summary sentence in a frequent appearance part database (DB) 151. The frequent appearance part DB 151 is stored in the storage unit 15.

Referring back to FIG. 3, the display controller 11E performs control such that the summary sentence is displayed, and performs control such that the frequent appearance parts of the words included in the summary sentence in the original text are displayed as the corresponding parts in the original text corresponding to the summary sentence in a case where the summary sentence is designated. The summary sentence and the corresponding parts in the original text corresponding to the summary sentence are displayed on, for example, a display unit of the terminal device 30.

Here, the corresponding part in a case where a specific word included in the summary sentence is designated may be different from the corresponding part in a case where the summary sentence is designated.

In a case where the plurality of summary sentences are acquired for the original text, the display controller 11E may perform control such that the summary sentences with corresponding parts and the summary sentences without corresponding parts are distinguishably displayed.

In a case where the summary sentence with the corresponding parts is designated, the display controller 11E performs control such that the frequent appearance parts of the words included in the summary sentence in the original text are displayed as the corresponding parts, and may perform control such that a predetermined part included in the original text (for example, cover or the like) is displayed in a case where the summary sentence without the corresponding part is designated.

In a case where there are a plurality of corresponding parts in the summary sentence, the display controller 11E may perform control such that the plurality of corresponding parts are displayed in a predetermined order. The predetermined order may be, for example, an order of pages or an order of index values (for example, TF-IDFs). In a case where there are the plurality of corresponding parts in the summary sentence, the display controller 11E may associate a word of which the index value (for example, TF-IDF) is the highest in each of the plurality of corresponding parts among the words included in the summary sentence with each of the plurality of corresponding parts, and may distinguishably display the word associated with the corresponding part in a case where the corresponding part is displayed.

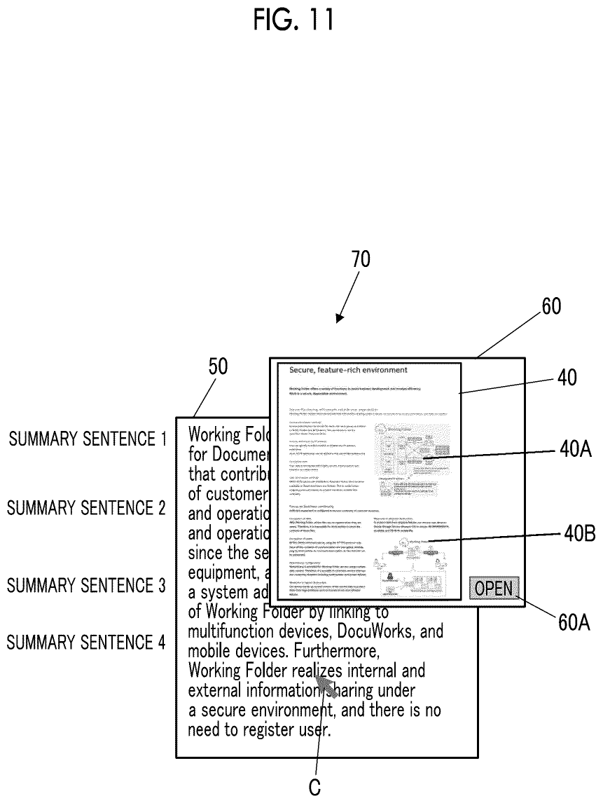

Here, corresponding part display processing by the display controller 11E will be specifically described with reference to FIGS. 11 to 15.

FIG. 11 is a front view illustrating an example of a corresponding part display screen 70 in a case where there is one corresponding part corresponding to the summary sentence. The corresponding part display screen 70 illustrated in FIG. 11 is displayed on, for example, the display unit of the terminal device 30.

The corresponding part display screen 70 illustrated in FIG. 11 displays the summary 50 divided into the summary sentences 1 to 4 described above. Since the summary sentences 1 and 2 have no corresponding parts in the original text, and the summary sentences 3 and 4 have corresponding parts in the original text, the summary sentences 1 and 2 and the summary sentences 3 and 4 are distinguishably displayed. In the example of FIG. 11, although the summary sentences 3 and 4 are highlighted in italics, the summary sentences may be highlighted by, for example, color, size, thickness, kind, and addition of underline of a font, addition of background color, or the like.

In FIG. 11, for example, in a case where the summary sentence 4 is designated with a cursor C of a mouse, the designated summary sentence 4 changes to bold and a preview screen 60 including the corresponding part in the original text is popped up. The designation mentioned herein is, for example, designation by a mouseover, mouse click, or the like. On the preview screen 60, a preview image of the original text page 40 including the original text paragraphs to 40C is displayed, and the original text paragraph corresponding to the summary sentence 4 is distinguishably displayed as the corresponding part. In the example of FIG. 11, the original text paragraph 40A is given a background color and highlighted, but the form of highlighting is not particularly limited. In a case where an “open” button 60A on the preview screen 60 is operated with the cursor C, “page 9” of the original text page 40 is displayed.

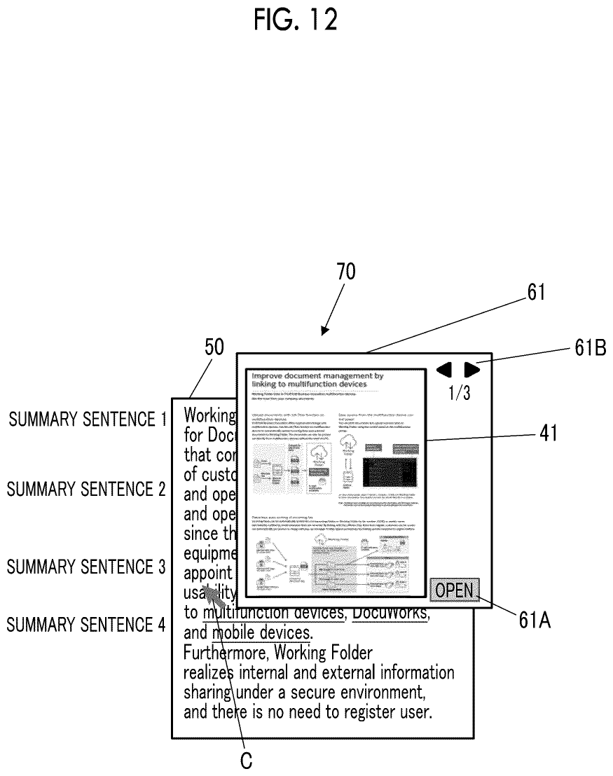

FIG. 12 is a front view illustrating an example of the corresponding part display screen 70 in a case where there are the plurality of corresponding parts corresponding to the summary sentence. The corresponding part display screen 70 illustrated in FIG. 12 is displayed, for example, on the display unit of the terminal device 30, as in the example of FIG. 11 described above.

The corresponding part display screen 70 illustrated in FIG. 12 displays the summary 50 divided into the summary sentences 1 to 4, as in the example of FIG. 11 described above. Since the summary sentences 1 and 2 have no corresponding parts in the original text, and the summary sentences 3 and 4 have corresponding parts in the original text, the summary sentences 1 and 2 and the summary sentences 3 and 4 are distinguishably displayed.

In FIG. 12, for example, in a case where the summary sentence 3 is designated with the cursor C of the mouse, the designated summary sentence 3 changes to bold and a preview screen 61 including the corresponding part in the original text is popped up. On the preview screen 61, preview images of a plurality of original text pages 41 to 43 (corresponding to “page 3”, “page 4”, and “page 7” of the original text) corresponding to the summary sentence 3 are displayed as corresponding parts. In the example of FIG. 12, “page 3” of the original text page 41 is displayed, and the pages to be displayed are switched in the order of pages in a case where page back and forward buttons 61B are operated with the cursor C. In a case where an “open” button 61A of the preview screen 61 is operated with the cursor C, “page 3” of the original text page 41 is displayed.

Here, in a case where “page 3” of the original text page 41 is displayed, a word associated with “page 3” (here, “multifunction devices”) may be distinguishably displayed. However, the word of “multifunction devices” is the word with the highest TF-IDF among the TF-IDFs 1 illustrated in FIG. 8 described above. In a case where “page 4” of the original text page 42 is displayed, a word associated with “page 4” (here, “DocuWorks (registered trademark)”) may be distinguishably displayed. However, the word of “DocuWorks (registered trademark)” has the highest TF-IDF among the TF-IDFs 2 illustrated in FIG. 8 described above. In a case where “page 7” of the original text page 43 is displayed, a word associated with “page 7” (here, “mobile devices”) may be distinguishably displayed. However, the word of “mobile devices” is the word with the highest TF-IDF among the TF-IDFs 3 illustrated in FIG. 8 described above.

A display order in a case where the plurality of original text pages 41 to 43 are displayed as the corresponding parts is not limited to the order of pages, and may be the order of index values (for example, the sum of TF-IDFs) as described above.

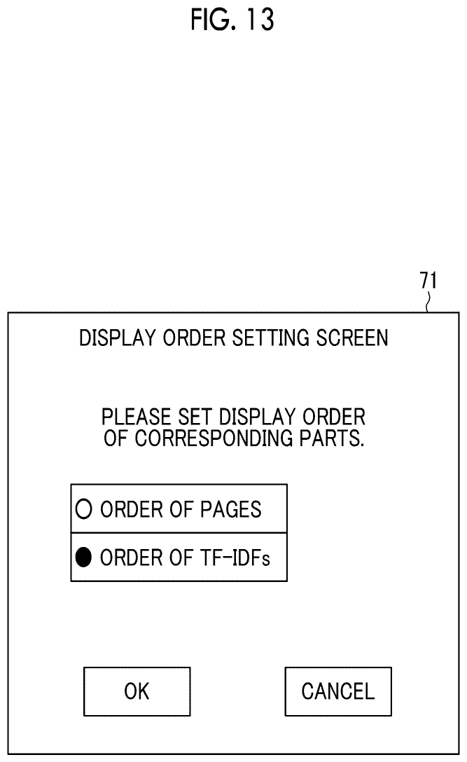

FIG. 13 is a front view illustrating an example of a display order setting screen 71 according to the present exemplary embodiment. A display order setting screen 71 illustrated in FIG. 13 is displayed on, for example, the display unit of the terminal device 30.

As illustrated in FIG. 13, in a case where the display order of the corresponding parts is set by the user through the display order setting screen 71 in order of TF-IDFs, the corresponding parts are displayed in descending order of the sum of TF-IDFs.

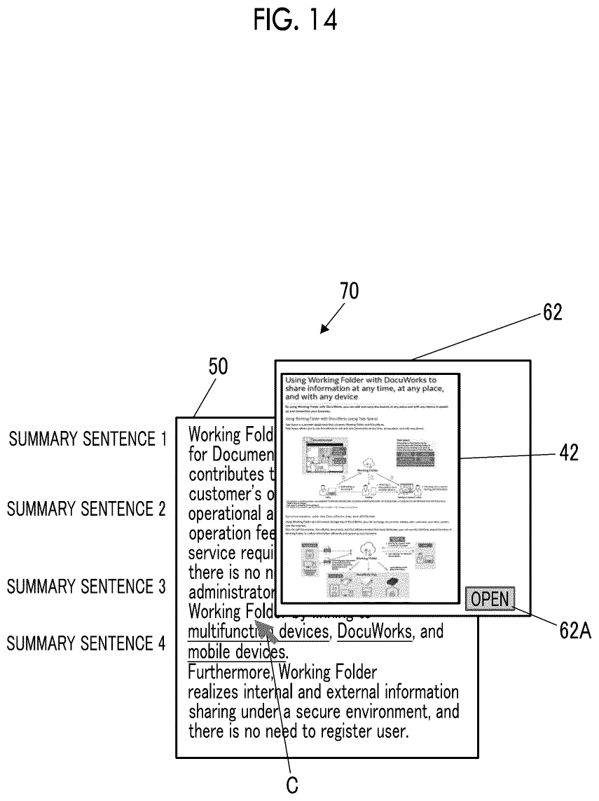

FIG. 14 is a front view illustrating an example of the corresponding part display screen 70 in a case where there is one corresponding part corresponding to the word in the summary sentence. The corresponding part display screen 70 illustrated in FIG. 14 is displayed, for example, on the display unit of the terminal device 30, as in the example of FIG. 11 described above.

The corresponding part display screen 70 illustrated in FIG. 14 displays the summary 50 divided into the summary sentences 1 to 4, as in the example of FIG. 11 described above. Since the summary sentences 1 and 2 have no corresponding parts in the original text, and the summary sentences 3 and 4 have corresponding parts in the original text, the summary sentences 1 and 2 and the summary sentences 3 and 4 are distinguishably displayed.

In FIG. 14, for example, in a case where specific words of the summary sentence 3 are designated with the cursor C of the mouse, a preview screen 62 including the corresponding parts in the original text corresponding to the designated words is popped up. The specific words are words with relatively high TF-IDFs (words with a threshold value or higher) in the summary sentence 3, and are, for example, “multifunction devices”, “DocuWorks (registered trademark)”, and “mobile devices”. These specific words are underlined and highlighted to be distinguished from the entire summary sentence. The highlighting method is not limited to underlining, as long as the highlighting method is a distinguishable method.

In the example of FIG. 14, “DocuWorks (registered trademark)” of the summary sentence 3 is designated with the cursor C, and a preview image of the original text page 42 corresponding to “DocuWorks (registered trademark)” (corresponding to “page 4” of the original text) is displayed as the corresponding part on the preview screen 62. That is, the corresponding parts in a case where the specific word included in the summary sentence 3 are designated are different from the corresponding parts in a case where the summary sentence 3 itself is designated. In a case where the “open” button 62A on the preview screen 62 is operated with the cursor C, “page 4” of the original text page 42 is displayed. In a case where “page 4” of the original text page 42 is displayed, a word associated with “page 4” (here, “DocuWorks (registered trademark)”) may be distinguishably displayed.

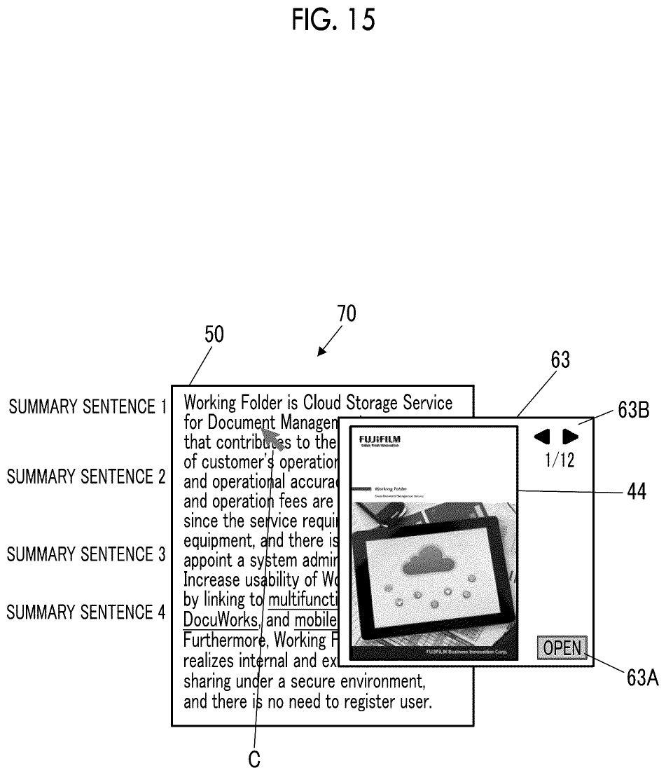

FIG. 15 is a front view illustrating an example of the corresponding part display screen 70 in a case where there is no corresponding part corresponding to the summary sentence. The corresponding part display screen 70 illustrated in FIG. 15 is displayed, for example, on the display unit of the terminal device 30, as in the example of FIG. 11 described above.

The corresponding part display screen 70 illustrated in FIG. 15 displays the summary 50 divided into the summary sentences 1 to 4, as in the example of FIG. 11 described above. Since the summary sentences 1 and 2 have no corresponding parts in the original text, and the summary sentences 3 and 4 have corresponding parts in the original text, the summary sentences 1 and 2 and the summary sentences 3 and 4 are distinguishably displayed.

In FIG. 15, for example, in a case where the summary sentence 1 is designated with the cursor C of the mouse, the designated summary sentence 1 changes to bold and a preview screen 63 including predetermined parts included in the original text is popped up. On the preview screen 63, a preview image of the original text page 44 (for example, “cover” of the original text) is displayed as an example of the predetermined part. That is, in a case where the summary sentence without the corresponding part is designated, the predetermined part included in the original text (for example, “cover” of the original text) is displayed. The page is not limited to the cover, and may be, for example, a first page of a body, an overview page, or the like. In a case where page back and forward buttons 63B are operated with the cursor C, the pages to be displayed are switched in the order of pages, and it is possible to preview the entire original text. In a case where an “open” button 63A on the preview screen 63 is operated with the cursor C, “cover” of the original text page 44 is displayed.

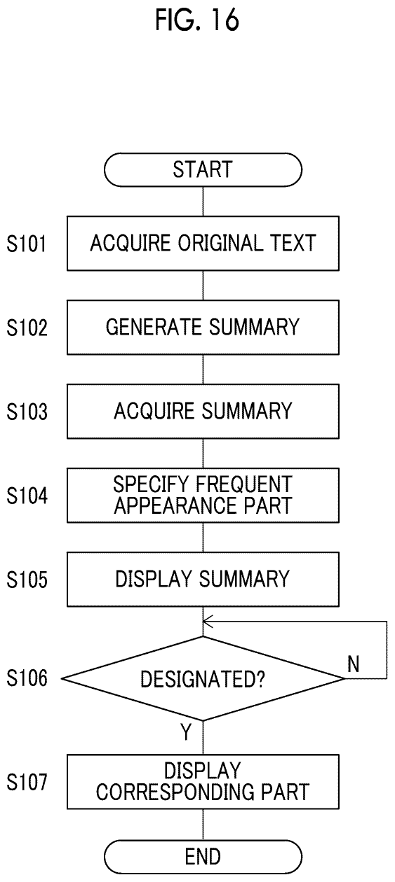

Next, an action of the summary processing apparatus 10 according to the present exemplary embodiment will be described with reference to FIG. 16.

FIG. 16 is a flowchart illustrating an example of a flow of processing by the summary processing program 15A according to the present exemplary embodiment.

First, the summary processing program 15A is started by the CPU 11 of the summary processing apparatus 10, and the following steps are executed.

In step S101 of FIG. 16, the CPU 11 acquires the original text to be summarized. The original text mentioned herein includes, for example, documents, images, moving images, dialogue and conversation histories, web pages, and the like as described above.

In step S102, the CPU 11 generates the summary sentence from the original text acquired in step S101. For example, a summary AI application (for example, “ELYZA DIGEST” or the like) is used to generate the summary sentence, as described above.

In step S103, the CPU 11 acquires the summary sentence generated in step S102 or a summary sentence from an external provider.

In step S104, the CPU 11 inputs the original text acquired in step S101, inputs the summary sentence acquired in step S103, and specifies frequent appearance parts of words included in the summary sentence in the original text. Specifically, as an example, as described above with reference to FIGS. 4 to 10 described above, for each word included in the summary sentence, an index value represented by the appearance frequency of the word and the degree of rarity of the word in the entire original text is calculated for each original text unit obtained by dividing the original text into predetermined units, and frequent appearance part is specified by using the calculated index value. The division unit may be, for example, a page unit or a chapter, clause, or paragraph unit. The frequent appearance part may not be a most frequent appearance part, and is, for example, a part where the sum of the index values calculated for each word included in the summary sentences is equal to or greater than a threshold value. For example, the TF-IDF is applied to the index value.

In step S105, the CPU 11 performs control such that the summary sentence is displayed as described above with reference to FIG. 11 described above, for example. For example, the corresponding part display screen 70 illustrated in FIG. 11 described above is displayed on the terminal device 30.

In step S106, as an example, the CPU 11 determines whether or not any of the plurality of summary sentences displayed on the corresponding part display screen 70 illustrated in FIG. 11 described above is designated by the user. The CPU proceeds to step S107 in a case where it is determined that the summary sentence is designated by the user (in the case of a positive determination), and waits in step S106 in a case where it is determined that the summary sentence is not designated by the user (in the case of a negative determination).

In step S107, as an example, as described with reference to FIG. 11 described above, the CPU 11 performs control such that the frequent appearance part of the word included in the summary sentence designated in step S106 in the original text is displayed as the corresponding part in the original text corresponding to the summary sentence, and ends a series of processing by the summary processing program 15A.

As described above, according to the present exemplary embodiment, the frequent appearance part of the word included in the summary sentence designated by the user in the original text is displayed as the corresponding part in the original text corresponding to the summary sentence. Accordingly, even though the summary sentences are not created by extracting key sentences from the original text, it is possible to display the corresponding parts of the original text for the summary sentence.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The summary processing apparatus has been described above as the example of the information processing apparatus according to the exemplary embodiment. The exemplary embodiment may be in the form of a program for causing a computer to execute the function of each unit included in the information processing apparatus. The exemplary embodiment may be in the form of a non-transitory computer readable medium storing these programs.

The configuration of the information processing apparatus described in the above exemplary embodiment is an example, and may be changed in accordance with a situation without departing from the scope.

The flow of processing of the program described in the above exemplary embodiment is also an example, and unnecessary steps may be deleted, new steps may be added, or the processing order may be changed without departing from the scope.

In the above exemplary embodiment, although a case where the processing according to the exemplary embodiment is implemented by a software configuration by using a computer by executing a program has been described, the present disclosure is not limited thereto. The exemplary embodiment may be implemented by, for example, a hardware configuration or a combination of hardware and software configurations.

The following matters are further disclosed for the above exemplary embodiment.

An information processing apparatus according to (((1))) comprising a processor configured to acquire a summary sentence obtained by summarizing an original text, and perform control such that frequent appearance parts of words included in the summary sentence in the original text are displayed as corresponding parts in the original text corresponding to the summary sentence in a case where the summary sentence is designated.

In accordance with an information processing apparatus according to (((2))), the information processing apparatus according to (((1))), wherein the processor is configured to calculate, for each word included in the summary sentence, an index value represented by an appearance frequency of the word and a degree of rarity of the word in the entire original text for each original text unit obtained by dividing the original text into predetermined units, and specify the frequent appearance part by using the calculated index value.

In accordance with an information processing apparatus according to (((3))), the information processing apparatus according to (((2))), wherein the frequent appearance part is a part where a sum of index values calculated for the words included in the summary sentence is equal to or greater than a threshold value.

In accordance with an information processing apparatus according to (((4))), the information processing apparatus according to (((2))) or (((3))), wherein the index value is TF-IDF.

In accordance with an information processing apparatus according to (((5))), the information processing apparatus according to any one of (((1))) to (((4))), wherein the processor is configured to specify a part where the word included in the summary sentence and a similar word of the word appear frequently as the frequent appearance parts.

In accordance with an information processing apparatus according to (((6))), the information processing apparatus according to any one of (((1))) to (((5))), wherein the corresponding part in a case where a specific word included in the summary sentence is designated is different from the corresponding part in a case where the summary sentence is designated.

In accordance with an information processing apparatus according to (((7))), the information processing apparatus according to any one of (((1))) to (((6))), wherein the processor is configured to perform control such that a summary sentence with the corresponding part and a summary sentence without the corresponding part are distinguishably displayed in a case where a plurality of the summary sentences are acquired for the original text.

In accordance with an information processing apparatus according to (((8))), the information processing apparatus according to (((7))), wherein the processor is configured to perform control such that the frequent appearance parts of the words included in the summary sentence in the original text are displayed as the corresponding parts in a case where the summary sentence with the corresponding part is designated and perform control such that a predetermined part included in the original text is displayed in a case where the summary sentence without the corresponding part is designated.

In accordance with an information processing apparatus according to (((9))), the information processing apparatus according to any one of (((1))) to (((8))), wherein the processor is configured to perform control such that a plurality of the corresponding parts are displayed in a predetermined order in a case where there is the plurality of corresponding parts in the summary sentence.

In accordance with an information processing apparatus according to (((10))), the information processing apparatus according to (((9))), wherein the processor is configured to associate a word of which an index value represented by an appearance frequency in each of the plurality of corresponding parts and a degree of rarity in the entire original text among words included in the summary sentence is highest with each of the plurality of corresponding parts in a case where there is the plurality of corresponding parts in the summary sentence.

In accordance with an information processing apparatus according to (((11))), the information processing apparatus according to any one of (((1))) to (((10))), wherein the summary sentence includes a first summary sentence and a second summary sentence before or after the first summary sentence, and the processor is configured to exclude one or more frequent appearance parts from a plurality of frequent appearance parts by using a contextual relationship with a frequent appearance part in the original text corresponding to the second summary sentence in a case where the plurality of frequent appearance parts are specified for the first summary sentence.

In accordance with an information processing apparatus according to (((12))), the information processing apparatus according to (((11))), wherein the processor is configured to exclude one or more frequent appearance parts from the plurality of frequent appearance parts by using at least one of a verb or an adjective related to a word included in the first summary sentence in addition to the contextual relationship with the frequent appearance part in the original text corresponding to the second summary sentence.

An information processing program according to (((13))) causing a computer to execute acquiring a summary sentence obtained by summarizing an original text, and performing control such that frequent appearance parts of words included in the summary sentence in the original text are displayed as corresponding parts in the original text corresponding to the summary sentence in a case where the summary sentence is designated.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
acquire a summary sentence obtained by summarizing an original text; and
perform control such that frequent appearance parts of words included in the summary sentence in the original text are displayed as corresponding parts in the original text corresponding to the summary sentence in a case where the summary sentence is designated.

2. The information processing apparatus according to claim 1, wherein the processor is configured to:
calculate, for each word included in the summary sentence, an index value represented by an appearance frequency of the word and a degree of rarity of the word in the entire original text for each original text unit obtained by dividing the original text into predetermined units; and
specify the frequent appearance part by using the calculated index value.

3. The information processing apparatus according to claim 2, wherein the frequent appearance part is a part where a sum of index values calculated for the words included in the summary sentence is equal to or greater than a threshold value.

4. The information processing apparatus according to claim 3, wherein the index value is TF-IDF.

5. The information processing apparatus according to claim 1, wherein the processor is configured to:
specify a part where the word included in the summary sentence and a similar word of the word appear frequently as the frequent appearance parts.

6. The information processing apparatus according to claim 1, wherein the corresponding part in a case where a specific word included in the summary sentence is designated is different from the corresponding part in a case where the summary sentence is designated.

7. The information processing apparatus according to claim 1, wherein the processor is configured to:
perform control such that a summary sentence with the corresponding part and a summary sentence without the corresponding part are distinguishably displayed in a case where a plurality of the summary sentences are acquired for the original text.

8. The information processing apparatus according to claim 7, wherein the processor is configured to:
perform control such that the frequent appearance parts of the words included in the summary sentence in the original text are displayed as the corresponding parts in a case where the summary sentence with the corresponding part is designated; and
perform control such that a predetermined part included in the original text is displayed in a case where the summary sentence without the corresponding part is designated.

9. The information processing apparatus according to claim 1, wherein the processor is configured to:
perform control such that a plurality of the corresponding parts are displayed in a predetermined order in a case where there is the plurality of corresponding parts in the summary sentence.

10. The information processing apparatus according to claim 9, wherein the processor is configured to:
associate a word of which an index value represented by an appearance frequency in each of the plurality of corresponding parts and a degree of rarity in the entire original text among words included in the summary sentence is highest with each of the plurality of corresponding parts in a case where there is the plurality of corresponding parts in the summary sentence.

11. The information processing apparatus according to claim 1, wherein the summary sentence includes a first summary sentence and a second summary sentence before or after the first summary sentence, and
the processor is configured to:
exclude one or more frequent appearance parts from a plurality of frequent appearance parts by using a contextual relationship with a frequent appearance part in the original text corresponding to the second summary sentence in a case where the plurality of frequent appearance parts are specified for the first summary sentence.

12. The information processing apparatus according to claim 11, wherein the processor is configured to:
exclude one or more frequent appearance parts from the plurality of frequent appearance parts by using at least one of a verb or an adjective related to a word included in the first summary sentence in addition to the contextual relationship with the frequent appearance part in the original text corresponding to the second summary sentence.

13. A non-transitory computer readable medium storing an information processing program causing a computer to execute:
acquiring a summary sentence obtained by summarizing an original text; and
performing control such that frequent appearance parts of words included in the summary sentence in the original text are displayed as corresponding parts in the original text corresponding to the summary sentence in a case where the summary sentence is designated.

14. An information processing method comprising:
acquiring a summary sentence obtained by summarizing an original text; and
performing control such that frequent appearance parts of words included in the summary sentence in the original text are displayed as corresponding parts in the original text corresponding to the summary sentence in a case where the summary sentence is designated.
